(19) United States
(12) Patent Application Publication
(10) Pub. No.: US 2002/0108229 A1
(43) Pub. Date: Aug. 15, 2002

(54) Method for the production of a hollow body

(76) Inventor: Fritz Rosch, Schwabach (DE)

Correspondence Address: Cooper & Dunham LLP, 1185 Avenue of the Americas, New York, NY, 10036, US

(21) Appl. No.: 10/058,686

(22) Filed: Jan. 28, 2002

Related U.S. Application Data
(63) Continuation of application No. PCT/EP00/07778, filed on Aug. 10, 2000.

(30) Foreign Application Priority Data
Aug. 17, 1999 (DE) 199 38 847.4

(51) Int. Cl. B23P 17/00

(52) U.S. Cl. 29/421.1

(57) ABSTRACT

A method for the production of a hollow body from aluminium sheet or alloyed aluminium sheet, especially a tank having at least one pipe mounted therein. Said method involves the following steps: preparing at least a cut flat sheet (10); placing at least one pipe (18) on the surfaces of the cut sheet to form inner surfaces of the hollow body being produced; folding and/or superimposing the cut sheet or sheets (10, 12) in such a way that a closed structure, with the exception of the inlet pipe and forming the hollow body by applying high pressure internally via the inlet pipe (18).

### FIELD OF THE INVENTION

The invention relates to a method for the production of a hollow body including at least one conduit arranged therein, more particularly a tank of aluminum or an aluminum alloy.

Hollow bodies including conduits arranged therein, typically tanks, firstly require the conduits to be sealed off hermetically from the exterior. Secondly, precautions need to be taken for venting, for inflow and outflow of the fluid, for gauging the fluid level as well as for further such means. For this purpose conduits are needed which are arranged at least in part within the hollow body; for example a vent conduit needs to be ported from the highest point of a tank to the exterior.

### PRIOR ART

Known from prior art are, for one thing, tanks made of sheet steel, fabricated by forming two half-shells separately from each other, for example by deep-drawing, into the required shape. After this, the necessary attached items such as e.g. the pump, all necessary conduits for supplying and venting the tank are attached in the interior of a half-shell. In conclusion, the two half-shells are superimposed and welded to each other along the adjoining edges.

Known also from prior art are tanks of plastics material in which the hollow body forming the tank is configured by blow molding, after which the necessary conduits are attached to the outside of the tank. Attaching conduits in the interior of the tank in this case is not possible, since the conduits cannot be included in the blank to be blow-molded into the hollow body. So that the various conduits are able to satisfy their function, they need to be ported into the interior of the tank by suitable connecting elements. These passages into the interior of the tank are particularly susceptible to leakage, this applying likewise to attaching the pump to the known plastics tanks by means of flanges and/or bolting with seals inserted between the surface areas adjoining each other. This procedure fails to ensure, however, that the seal is made to the high safety code requirements which are slated to become even more stringent in the near future.

In addition to the requirement for ensuring best possible sealing to the exterior whilst retaining the possibility of providing fittings such as conduits and pumps, substantial aspects exist in fabricating a hollow body, more particularly a tank, in that this needs to be configured simultaneously rugged and as lightweight as possible by simple and cost-effective means of fabrication.

The requirement for a lightweight tank is satisfied, for example, by making use of aluminum or an aluminum alloy for producing the hollow body in thus selecting a material for the hollow body which, for one thing, results in a rugged design of the hollow body, more particularly of a tank, and for another, achieves an acceptable weight of the resulting tank. However, using aluminum or aluminum alloy, due to the special features of this material, especially its poor properties in permitting shaping and suitability for welding, results in the method as used with success for tanks of sheet steel failing to be suitable for this purpose. For one thing, complicated tank shapes posing no problem when being configured of sheet steel, cannot be drawn from sheet aluminum without problems. For another, the welding properties of aluminum or aluminum alloy are not conducive to welding two half-shells of aluminum to each other fully circumferentially.

This is why for fabricating a hollow body of aluminum special methods of production need to be selected which also find application in the method in accordance with the invention. In this arrangement, substantially one or more flat sheet metal blanks are folded and superimposed before being joined to each other at their edges such that with the exception of at least one inlet conduit a closed configuration materializes. Subsequently an internal high pressure is introduced therein by hydraulic or pneumatic means so that the sheet metal blanks joined to each other form a hollow body by being, so-to-speak, inflated or pumped up to shape.

One such method of producing a hollow body, more particularly a tank of aluminum is disclosed by DE 195 31 035. The method as described therein involves in superimposing the sheet metal blanks of aluminum and joining their edges in part, inserting the joined sheet metal blanks into a suitable closable die and introducing heated oil between the sheet metal blanks, as a result of which they are deformed in being bulged to form the hollow body. In this arrangement the oil is introduced through a socket soldered in place between the sheet metal blanks. Further conduits such as for example vent conduits may be likewise soldered to the edge zones of the sheet metal layers. As regards the aspects of the method of producing hollow bodies of aluminum sheet as described above reference is also made to the aforementioned disclosure of the present applicant as well as to the prior art DE 198 51 259 filed by the applicant, the disclosure of which as regards the method of production of hollow bodies of sheet aluminum or of aluminum alloy is becoming the subject matter of the present application by this reference.

It is to be noted, however, that the required seal can hardly be assured at the solder locations of the various conduits in the edge zones between two sheet metal blanks.

### SUMMARY OF THE INVENTION

Accordingly, the objective of the invention is to provide a method for the production of a hollow body including at least one conduit arranged therein by means of which a rugged, lightweight hollow body hermetically sealed to the exterior can be configured by cost-effective ways and means.

This objective is achieved by the method as described in claim 1.

In the scope of the present invention the possibility of providing the necessary conduits is indicated in the cited methods of production without risking leakage of the container to the exterior. This is achieved in accordance with the invention by the necessary conduits, namely a vent conduit and/or a supply and return conduit, being attached to the sheet metal blank(s) at the later inner surface areas of the hollow body to be formed prior to the sheet metal blanks being folded and/or superimposed. In this case making use of sheet aluminum and the aforementioned method of production offers the substantial advantage as compared to a method of production of plastics tanks that machining the inner surface areas of the hollow body to be formed and more particularly attaching the conduits is now possible before the superimposed or folded sheet metal blanks are formed into the hollow body. In the condition in which it is superimposed or folded the resulting intermediate product thus features a certain thickness which is increased only unsubstantially by prior application and securement of the necessary conduits and which does not impair shaping by the application of internal high pressure.

Attaching conduits in the interior of the resulting hollow body offers the salient advantage that these now no longer need to be ported to the exterior which results in the leakage problems as described above and which are unavoidable where a plastics tank is concerned. Instead, in accordance with the invention the conduits now remain in the interior of the tank. For example, the vent conduit (breather) as in always required can now be ported in the interior of the tank and the corresponding filler neck ported from the highest point of the tank to the outlet location of the filler neck. In addition, supply conduits, provided between the various zones of a complicated shaped tank and between several pumps, where necessary, can now be installed prior to folding the sheet metal blanks and shaping the hollow body and attached to the inner surface areas so that in this case too, no sensitive locations materialize liable to become leaky.

The method in accordance with the invention in which, due to using aluminum, the procedure as when working steel is not applicable, now achieves in all and for the first time a hollow body of aluminum in keeping with requirements. More particularly, the method in accordance with the invention permits fabrication of a tank satisfying the sealing requirements which is provided with the necessary conduits and other fittings whilst being made of aluminum or aluminum alloy which hitherto could not be used for fabricating tanks of this type.

Preferred further embodiments of the invention read from the further claims.

Experience has shown it to be good practice to attach the conduits by means of hook mounts to the inner surface areas of the hollow body to be formed.

Attaching the conduits by means of hook mounts can be rendered particularly simple and reliable by spot welding the hook mounts to the inner surface areas.

In conclusion, the method in accordance with the invention can be further sophisticated by attaching a pump and/or the fittings needed in conjunction with an electric level gauge to the tank by producing an opening in the tank and subsequently closing it off with a cover into which the cited fittings are fixedly installed. The cover can be hermetically sealed for example by welding or soldering to the relatively short rim of the configured opening so that here too there is no fear of leakage materializing.

### BRIEF DESCRIPTION OF THE DRAWINGS

One embodiment of the method in accordance with the invention will now be detailed with reference to the drawings in which

FIG. 1 is a diagrammatic view of two sheet metal blanks superimposed and provided with the necessary conduits;

FIG. 2 is a diagrammatic view of the formed tank provided with a opening for fitting a pump; and

FIG. 3 is a diagrammatic view of a tank provided with a pump.

### DETAILED DESCRIPTION OF A PREFERRED EMBODIMENT OF THE INVENTION

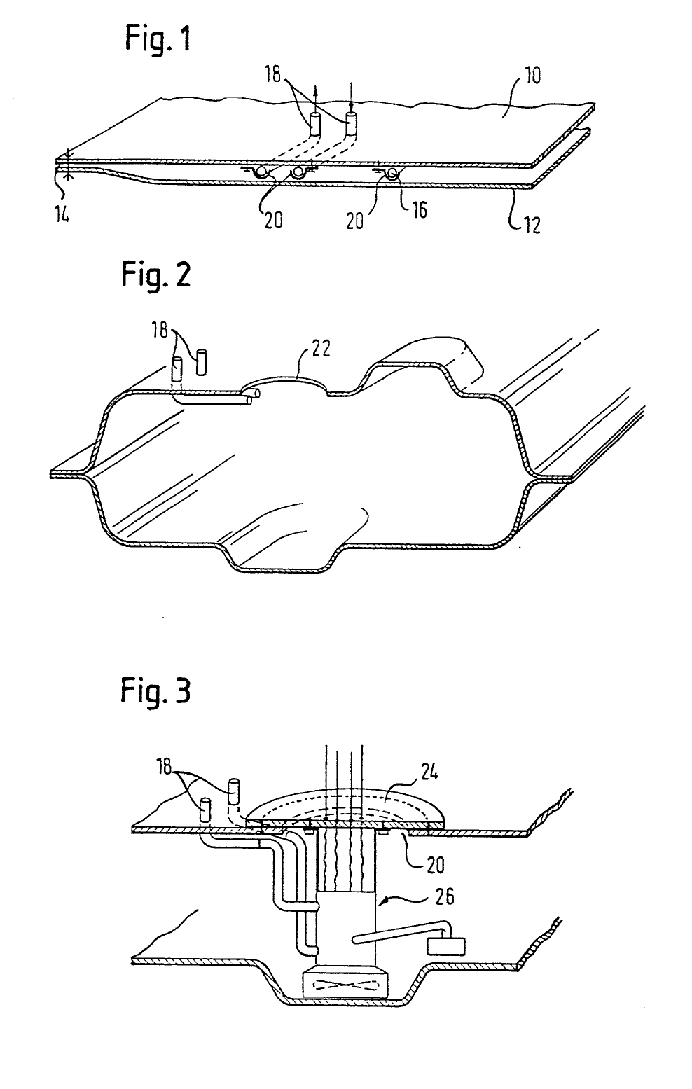

Referring now to FIG. 1 there is illustrated a condition in which two flat sheet metal blanks 10 and 12 are superimposed and joined to each other along their edges 14. In this arrangement and in the scope of the method in accordance with the invention it has already been provided for that the necessary conduits, for example a vent conduit 16 as well as a supply and return conduit 18 to and from the engine are attached to the upper sheet metal blank 10 at the surface area thereof which in the final condition represents an inner surface area of the hollow body to be formed. Being able to attach the conduit to the later inner surface area of the sheet metal blank 10 is now possible in making use of sheet aluminum in accordance with the invention contrary to forming the hollow body from a plastics blank because the sheet metal blanks are initially provided separately from each other and subsequently superimposed. This is the case in the method both in accordance with the DE 195 31 035 C2 of the applicant and in accordance with the application as per DE 196 51 259 by which a single sheet metal blank is suitable folded before the edge zones are joined to each other.

In the case as shown, the conduits 16, 18 are attached to the inner surface area of the sheet metal blank 10 by several hook mounts 20 which may be secured by spot welding to the sheet metal blank 10 as is indicated in the drawing diagrammatically. The example embodiment shown further exhibits the special feature of the conduits leading to and from the engine being ported through the sheet metal blank 10 which is, however, now possible by suitable jointing procedures in such a way that the seal in this zone is not detrimented.

Referring now to FIG. 2 there is illustrated how the sheet metal blanks 10, 12 as thus prepared are subsequently finished by introducing an internal high pressure between them, as described in detail in the aforementioned disclosures, where necessary in conjunction with a cavity die in which the blanks to be joined to each other are inserted, in becoming unfolded and/or bulged to thus produce the hollow body as shown diagrammatically in FIG. 2. Subsequently, an opening 22 is formed therein into which a cover mounting further fittings can be inserted.

Referring now to FIG. 3 there is illustrated the latter aspect diagrammatically involving incorporated in the cover 24 a fuel pump 26 to which the fittings and wiring as needed in conjunction with a level gauge. The supply and return conduits are connected to the pump in the interior of the tank which is now made possible in the scope of fabrication by configuring the opening 22 with a suitable large diameter, at least 100 mm, so that the necessary conduits can be connected manually in locating the cover 24 with the pump 26 attached thereto. This cover 24 can subsequently be hermetically sealed to the rim of the opening 22 by welding or soldering so that in this zone too, there is no risk of leakage in the resulting tank. Accordingly, in accordance with the invention a hollow body of aluminum or aluminum alloy sheet metal is achieved by means of suitable methods of fabrication which is already provided with the necessary fittings whilst nevertheless assuring a good seal.

1. A method for the production of a hollow body of sheet aluminum or aluminum alloy, more particularly a tank, including at least one conduit (16, 18) arranged therein, comprising the following steps:
providing at least one flat sheet metal blank (10, 12),
attaching at least one conduit (16, 18), namely a vent conduit (16) and/or a supply and return conduit (18), to the surface areas of said sheet metal blank (10) which form the inner surface areas of the hollow body to be formed,
folding and/or superimposed said sheet metal blank(s) (10, 12) and joining the edge portions (14) to each other such that—with the exception of at least one additionally provided inlet conduit—a closed structure materializes, and
forming said hollow body by applying an internal high pressure via said inlet conduit.

2. The method as set forth in claim 1, characterized in that said conduits (16, 18) are attached in making use of hook mounts (20).

3. The method as set forth in claim 2, characterized in that said hook mounts (20) are spot welded to said inner surface areas.

4. The method as set forth in any of the preceding claims, characterized in the subsequently the formed hollow body is opened and a cover (24) including a pump (26) fitted thereto and/or further fittings is attached thereto by said cover (24) being hermetically sealed, more particularly, welded or soldered to the hollow body.
